(19) United States
(12) Patent Application Publication
(10) Pub. No.: US 2026/0229251 A1
(43) Pub. Date: Aug. 6, 2026

(54) MAGNETIC RECORDING MEDIUM WITH AMORPHOUS METALLIC ALLOY OVERCOAT AND MAGNETIC RECORDING APPARATUS FOR USE THEREWITH

(71) Applicant: Western Digital Technologies, Inc., San Jose, CA (US)

(72) Inventors: Georgi Georgiev Diankov, Walnut Creek, CA (US); Ge Xu, San Jose, CA (US); Daniel Demori Maksuta, San Jose, CA (US)

(21) Appl. No.: 19/044,189

(22) Filed: Feb. 3, 2025

(51) Int. Cl. G11B 5/72; G11B 5/00; G11B 5/65; G11B 5/66; G11B 5/851

(52) U.S. Cl. CPC G11B 5/72; G11B 5/657; G11B 5/66; G11B 5/851; G11B 2005/0021

(57) ABSTRACT

Various apparatuses, devices, methods, and media are disclosed for heat-assisted magnetic recording (HAMR) or perpendicular magnetic recording (PMR), wherein a magnetic recording medium is provided that includes an overcoat formed of an amorphous metallic alloy. In some aspects, the overcoat may be formed of one or more of TaAuCrRu, AuRuSiOₓC (0≤x≤2), TaCrRuC, NbPdHf, NbPdHfW, NbPdHfSi, PdHfSi and NbPdHfWCrB. In some aspects, the amorphous metallic alloy compound may be an amorphous multi-principal element alloy (MPEA). For example, the amorphous metallic alloy overcoat may be an MPEA formed of 20Pd-20Nb-20Hf-20W-(remainder Cr and B). In other examples, the amorphous metallic alloy of the overcoat has principal elements that each vary from 5 to 35 atomic percentage (at. %) with all elements of the alloy totaling 100 at. %. In one example, the amorphous metallic alloy is 30Pd-11Nb-35Hf-10W-10Cr-4B. In other examples, other amorphous metallic alloy compositions may be suitable, such as families of iridium-containing metallic glasses.

### FIELD

The disclosure relates, in some aspects, to magnetic recording media and to magnetic recording apparatus for use with magnetic recording media. More specifically, but not exclusively, the disclosure relates to magnetic recording media configured for use with perpendicular magnetic recording (PMR) or heat-assisted magnetic recording (HAMR).

### INTRODUCTION

Magnetic storage systems, such as a hard disk drive (HDD), are utilized in a wide variety of devices in stationary and mobile computing environments. Examples of devices that incorporate magnetic storage systems include data center servers, desktop computers, portable notebook computers, portable hard disk drives, high-definition television (HDTV) receivers, television set-top boxes, video game consoles, and portable media players.

A typical disk drive includes magnetic storage media in the form of one or more flat disks. The disks are generally formed of few main substances, namely, a substrate material that gives it structure and rigidity, a magnetic recording layer that holds the magnetic bits that store digital data, and media overcoat and lubricant layers to protect the magnetic recording layer. The typical disk drive also includes a read head and a write head, generally in the form of a magnetic transducer which can sense and/or change the magnetic moments stored on the recording layer of the disks.

Many magnetic recording disks for use in HDDs are configured for perpendicular magnetic recording (PMR). PMR, also known as conventional magnetic recording (CMR), operates by aligning the poles of magnetic elements of a magnetic recording layer (MRL) perpendicularly to the surface of the disk. The magnetic elements represent bits of data. PMR disk designs often include a protective carbon overcoat, such as diamond-like carbon (DLC).

Heat-assisted magnetic recording (HAMR) systems can increase the areal density of information recorded magnetically on various magnetic media. To achieve higher areal density for magnetic storage, smaller magnetic grain sizes (e.g., less than 6 nanometers (nm)) may be required. The reduction in size, however, makes the magnetic moments of the bits thermally unstable, requiring a corresponding increase in magnetic anisotropy. In HAMR, high temperatures are applied to the media during writing to facilitate recording to such small grains with high magnetic anisotropy. The high temperatures may be achieved using a near field transducer that is coupled to a laser diode of a slider of a HAMR disk drive. HAMR media also often include a carbon overcoat.

The state-of-the-art carbon overcoat films for HDD media such as DLC films are reaching their practical limits as the thickness of the carbon overcoat has been progressively reduced to a current range of 21.5-22 Angstroms for the PMR technology and similar thickness for HAMR. Below this limit, carbon overcoat tends to fail, with increased corrosion and deterioration of mechanical properties that can lead to drive failure. In particular, DLC is a hard and robust material, but its density is low. Below a certain thickness, voids and pinholes present in the DLC provide paths for undesirable Co diffusion from the underlying magnetic layers.

It would be desirable to provide an alternative material for use as an overcoat for HDD media and aspects of the present disclosure are directed to that end.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one embodiment, a magnetic recording medium is provided that includes: a substrate; a magnetic recording layer on the substrate; and an overcoat comprising an amorphous metallic alloy (e.g., metallic glass or amorphous multi-principal element alloy) on the magnetic recording layer. The amorphous metallic alloy may be, for example, a metallic glass such as TaAuCrRu, AuRuSiOₓC (with x typically between 1 and 2, inclusive), TaCrRuC, NbPdHf, NbPdHfW, NbPdHfSi, PdHfSi and NbPdHfWCrB. In one specific composition, the metallic glass may be 30Pd-11Nb-35Hf-10W-10Cr-4B. In other examples, the metallic glass may include Ir.

In another embodiment, a method for fabricating a magnetic recording medium is provided. The method includes: providing a substrate; providing a magnetic recording layer on the substrate; and providing an overcoat comprising an amorphous metallic alloy on the magnetic recording layer. The amorphous metallic alloy may be, for example, a metallic glass such as TaAuCrRu, AuRuSiOₓC (with x typically between 1 and 2, inclusive), TaCrRuC, NbPdHf, NbPdHfW, NbPdHfSi, PdHfSi and NbPdHfWCrB. In one example, the metallic glass may be 30Pd-11Nb-35Hf-10W-10Cr-4B. In other examples, the metallic glass may include Ir. In some aspects, the amorphous metallic alloy may be an MPEA.

In another embodiment, a magnetic recording medium is provided that includes: a substrate; a heatsink layer on the substrate; a seed layer on the heatsink layer; a magnetic recording layer on the seed layer; and an overcoat comprising a metallic glass on the magnetic recording layer. In one example, the metallic glass may be 30Pd-11Nb-35Hf-10W-10Cr-4B.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 is a top schematic view of an exemplary disk drive configured for heat-assisted magnetic recording (HAMR) including a slider and a HAMR medium that includes an overcoat formed of a metallic glass or other amorphous metallic alloy, in accordance with an aspect of the disclosure.

FIG. 2 is a side schematic view of the exemplary slider and HAMR medium of FIG. 1 in accordance with an aspect of the disclosure.

FIG. 3 is a side schematic view of an exemplary magnetic recording medium configured for use with HAMR that includes, among other layers, an overcoat formed of a metallic glass or other amorphous metallic alloy, in accordance with an aspect of the disclosure.

FIG. 4 is a flowchart of an exemplary process for fabricating a HAMR medium that includes, among other layers, an overcoat formed of a metallic glass or other amorphous metallic alloy, in accordance with an aspect of the disclosure.

FIG. 5 is a side schematic view of an exemplary magnetic recording medium configured for use with perpendicular magnetic recording (PMR) that includes, among other layers, an overcoat formed of a metallic glass or other amorphous metallic alloy, in accordance with an aspect of the disclosure.

FIG. 6 is a flowchart of an exemplary process for fabricating a PMR medium that includes, among other layers, an overcoat formed of a metallic glass or other amorphous metallic alloy, in accordance with an aspect of the disclosure.

FIG. 7 is a side schematic view of another exemplary magnetic recording medium, in accordance with an aspect of the disclosure.

FIG. 8 is a flowchart of another exemplary process for fabricating a magnetic recording medium, in accordance with an aspect of the disclosure.

FIG. 9 is a graph showing lubricant uptake, i.e., the amount of lubricant that is retained on the overcoat when the magnetic recording disk is dipped into a lubricant bath, for a carbon overcoat (COC) and for a metallic glass in accordance with an aspect of the disclosure.

FIG. 10 is a graph showing lubricant bonding, i.e., the amount of lubricant that remains on the overcoat despite extended baking times, for a COC and for a metallic glass in accordance with an aspect of the disclosure.

FIG. 11 is a graph showing lubricant loss rate for a COC and for a metallic glass in accordance with an aspect of the disclosure.

FIG. 12 is a graph showing corrosion resistance for a metallic glass in accordance with an aspect of the disclosure.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to apparatuses, systems, methods, and magnetic recording media for use with heat-assisted magnetic recording (HAMR) or perpendicular magnetic recording (PMR). In particular, a magnetic recording medium is described that is configured to, among other features, enhance a readback signal during HAMR or PMR by employing an overcoat layer with reduced thickness to permit positioning of a slider very close to the magnetic recording layer (MRL) of the media. The overcoat layer also provides good hardness, corrosion resistance, and other desirable overcoat layer characteristics.

In some aspects, these and other features are achieved by providing an overcoat formed of an amorphous metallic alloy such as a metallic glass. Herein, an amorphous metallic alloy is a solid non-crystalline metallic alloy with a disordered atomic-scale structure. Herein, a metallic glass is a type of amorphous metallic alloy that has the characteristics of a glass, i.e., a metallic glass can be described as having a dense random packing of its atoms. Note that some technologists in this field regard an “amorphous metallic alloy” as a “disordered” or “dirty” metal, in which disorder has been introduced via impurities, irradiation, or other means, or regard the term as referring to metallic nanoparticles that are too small to have a well-defined crystal structure. Herein, no such limitation is implied.

In some aspects, the overcoat may be formed of one or more of TaAuCrRu, AuRuSiOₓC, TaCrRuC, NbPdHf, NbPdHfW, NbPdHfSi, PdHfSi and NbPdHfWCrB. Insofar as AuRuSiOₓC is concerned, x may between 0 and 2, inclusive (i.e., 0≤x≤2), and, typically, x is between 1 and 2, inclusive (i.e., 1≤x≤2). A preferred value for x for use with the compound may be determined for different applications without undue experimentation. In some aspects, the amorphous metallic alloy compound may be an amorphous multi-principal element alloy (MPEA). (Note that MPEAs are often crystalline but can be amorphous, and the MPEAs described herein are amorphous MPEA metallic glasses, not crystalline MPEAs.) With an MPEA, the principal elements of the alloy are present in about equal proportions. By way of example, the amorphous metallic alloy overcoat may be formed of 20Pd-20Nb-20Hf-20 W and a remainder of Cr and B. (Note that all compositional percentages expressed herein are atomic percentages (at. %), i.e., 20Pd means that 20 at. % of the alloy is Pd.) In other aspects, the amorphous metallic alloy of the overcoat has principal elements that each vary from 5 to 35 at. % with all elements of the alloy totaling 100 at. %. That is, the amorphous metallic alloy of the overcoat need not be an MPEA. In one particular example, the amorphous metallic alloy is 30Pd-11Nb-35Hf-10W-10Cr-4B. Otherwise routine experimentation (e.g., phase mapping) may be performed to identify preferred or optimal values for the atomic percentages of the various elements within the alloys. In other examples, other amorphous metallic alloy compositions may be suitable, such as families of iridium (Ir)- and Ir-nickel (Ni)-containing metallic glasses. Generally speaking, good candidates for amorphous metallic alloys include combinations of elemental components that (a) provide a negative enthalpy of mixing (b) with atoms of different size to promote amorphous packing and (c) with a maximum entropy for the alloy. The amorphous state of the alloy can be confirmed using X-ray diffraction.

In some examples, the density of the amorphous metallic alloy overcoat can be six to seven times greater than that a conventional carbon overcoat (COC) such as a diamond-like carbon (DLC) film. The greater density permits a reduction in the thickness of the overcoat as compared to a COC while providing sufficient overcoat protection. Moreover, when using a lubricant on the amorphous metallic alloy overcoat, lubricant uptake is at least as effective as with a conventional COC without needing N₂ implantation. That is, when using a suitable amorphous metallic alloy overcoat in a magnetic recording medium, an N—C interface layer is not needed between the lubricant of the medium and the overcoat of the medium, as is often required with a COC. In some examples, lubricant binding/bonding to the amorphous metallic alloy overcoat is one to three orders of magnitude greater than with a conventional COC. Thermal stability of the amorphous metallic alloy can be achieved up to at least 600° C. as compared to 300° C. for many conventional COCs, thus permitting the use of the amorphous metallic alloy overcoat for HAMR. The amorphous metallic alloy overcoat may be formed using direct current (DC) sputtering, rather than chemical vapor deposition (CVD) as with the typical COC. DC sputtering is generally preferred over CVD because DC sputtering has less process variations, i.e. DC sputtering has a tighter process delta.

TABLE I summarizes some of these features.

TABLE I

| | | Amorphous | Advantages of |
|---|---|---|---|
| | | metallic | Amorphous |
| | COC | alloy film | metallic |
| | Technology | technology | alloy film |
| Overcoat | Hydrocarbon | Amorphous | |
| Material | film | metallic alloy | |
| | | film (e.g. | |
| | | metallic glass) | |
| Film | 2.0-2.2 g/cm³ | 13-15 g/cm³ | Much higher density, |
| Density | | | enables thin overcoat |
| Deposition | CVD w/CₓH_{y} | DC sputter | Tight process delta, |
| | gas | | enables thin overcoat |
| Lubricant | Generally poor, | Good without a | Enables thin overcoat, |
| Affinity | usually needs | nitrogen interface | saves sputter chamber |
| | nitrogen interface | layer | |
| | layer | | |
| Thermal | Degradation | Stable up to at | Useful for HAMR |
| Stability | >300° C. | least 600° C. | media, as well as PMR |

Herein-below, examples are described wherein the magnetic recording medium is configured for HAMR. Other examples described below provide a magnetic recording medium configured for PMR. Prior to describing the examples, a data storage device is described for use with HAMR. It should be understood that a similar data storage device may be provided for PMR that would omit the laser heating elements of the slider.

Although the primary examples described herein are magnetic recording medium examples, the amorphous metallic alloys disclosed herein may be used in a wide range of other applications, not limited to magnetic recording. Generally speaking, the amorphous metallic alloys disclosed herein might be used in any application that might benefit. In some aspects, the present disclosure presents what the inventors believe to be novel amorphous metallic alloy compounds, particularly TaAuCrRu, AuRuSiOₓC, TaCrRuC, NbPdHf, NbPdHfW, NbPdHfSi, PdHfSi and NbPdHfWCrB. In some aspects, structures may be provided that include some form of base structure or substrate with one or more of the amorphous metallic alloy compounds described herein coated thereon. In some aspects, one or more of the amorphous metallic alloy compounds described herein may be used as medical instruments (e.g., surgical knives), electronic device casings, armor-piercing ammunition, specialized components in aerospace and automotive industries, and protective coatings for industrial machinery. These are just some examples. The compounds may be used in a wide variety of applications where high strength and wear resistance are important while maintaining a lightweight design or where very thin coatings are advantageous.

### Data Storage Device Example

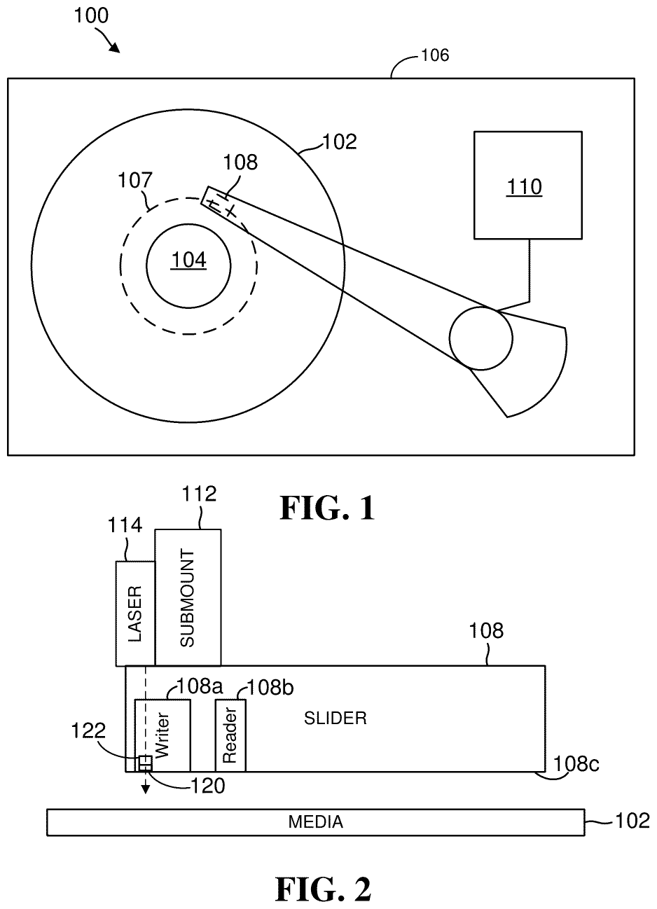

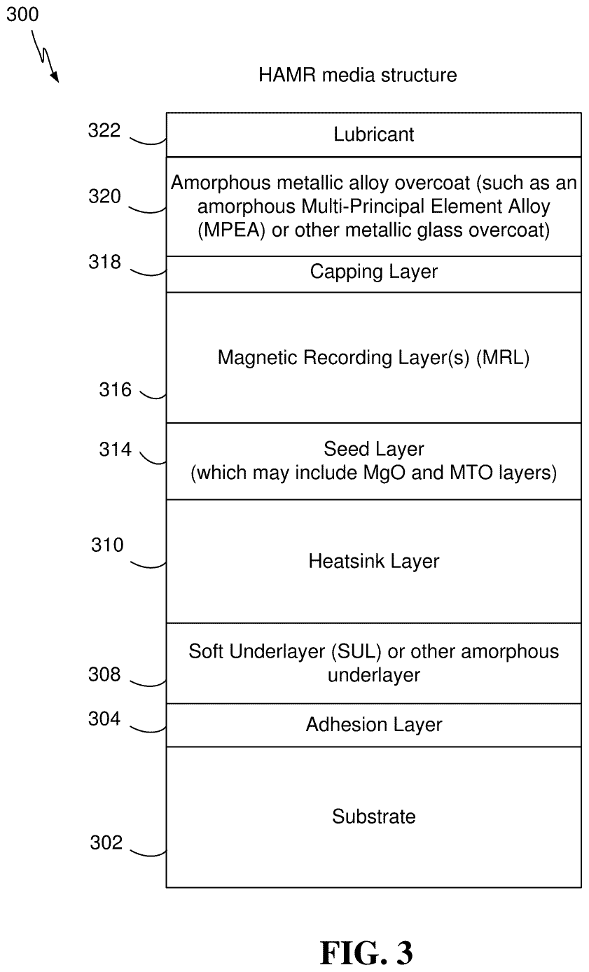

FIG. 1 is a top schematic view of a data storage device 100 (e.g., disk drive or magnetic recording device) configured for magnetic recording and comprising a slider 108 and a magnetic recording medium 102. In this example, the magnetic recording medium 102 includes a HAMR medium that includes an amorphous metallic alloy overcoat (not shown in FIG. 1, but see FIG. 3). The laser (not visible in FIG. 1 but see 114 in FIG. 2) is positioned with a magnetic head/slider 108. Disk drive 100 may comprise one or more disks/media 102 to store data. Disk/media 102 resides on a spindle assembly 104 that is mounted to a drive housing 106. Data may be stored along tracks in the magnetic recording layer of disk 102. The reading and writing of data are accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR) based elements, such as tunnel magneto-resistive (TMR) elements for reading, and a write pole with coils that can be energized for writing. In operation, a spindle motor (not shown) rotates the spindle assembly 104 and thereby rotates the disk 102 to position the head 108 at a particular location along a desired disk track 107. The position of the head 108 relative to the disk 102 may be controlled by the control circuitry 110 (e.g., a microcontroller). It is noted that while an exemplary HAMR system is shown, at least some aspects of the disclosure may be used in other HAMR or Energy-Assisted MR (EAMR) magnetic data recording systems or in non-HAMR or non-EAMR magnetic data recording systems, including shingle-written magnetic recording (SMR) media, microwave assisted magnetic recording (MAMR) media, or the above-mentioned PMR.

FIG. 2 is a side schematic view of the slider 108 and magnetic recording medium 102 of FIG. 1. The magnetic recording medium 102 includes an amorphous metallic alloy (not shown in FIG. 1, but see FIG. 3). The amorphous metallic alloy may be, e.g., one or more of TaAuCrRu, AuRuSiOₓC, TaCrRuC, NbPdHf, NbPdHfW, NbPdHfSi, PdHfSi and NbPdHfWCrB. The slider 108, which may also be referred to as a head, may comprise a sub-mount 112 attached to a top surface of the slider 108. The laser 114 may be attached to the sub-mount 112, and possibly to the slider 108. The slider 108 comprises a write element (e.g., writer) 108a and a read element (e.g., reader) 108b positioned along an air bearing surface (ABS) 108c of the slider for writing information to, and reading information from, respectively, the media 102. In other aspects, the slider may also comprise a layer of Si or Si cladding 120. This layer is optional. In still other aspects, the slider may include an amorphous metallic alloy protective coating, such as such as one or more of TaAuCrRu, AuRuSiOₓC, TaCrRuC, NbPdHf, NbPdHfW, NbPdHfSi, PdHfSi and NbPdHfWCrB.

In operation, the laser 114 is configured to generate and direct light energy to a waveguide (e.g., along the dashed line) in the slider which directs the light to a near field transducer (NFT) 122 near the air bearing surface (e.g., bottom surface) 108c of the slider 108. Upon receiving the light from the laser 114 via the waveguide, the NFT 122 generates localized heat energy that heats a portion of the media 102 within or near the write element 108a. The anticipated recording temperature is in the range of about 350° C. to 400° C. or higher (e.g., 600° C.). In the aspect illustrated in FIG. 2, the laser directed light is disposed within the writer 108a and near a trailing edge of the slider. In other aspects, the laser directed light may instead be positioned between the writer 108a and the reader 108b. FIGS. 1 and 2 illustrate a specific example of a HAMR system. In other examples, the magnetic recording medium 102 can be used in other suitable HAMR systems (e.g., with other sliders configured for HAMR).

### HAMR Media Example

FIG. 3 is a side schematic view of an exemplary HAMR medium 300 configured for use with HAMR that includes an amorphous metallic alloy overcoat in accordance with an aspect of the disclosure. The HAMR medium 300 of FIG. 3 has a stacked structure with a substrate (which may be formed, e.g., of glass or a glass ceramic) 302 at a bottom/base layer, an adhesion layer 304 (which may be formed, e.g., of NiTa) on the substrate 302, an soft underlayer (SUL) 308 (which may be formed, e.g., of CoZrWMo) on the adhesion layer 304, a heatsink layer 310 (which may be formed, e.g., of Cr) on the SUL 308, a seed layer 314 (which may include MgO and Ti-doped MGO (MTO) layers with the MgO layer on top of the MTO layer) on the heatsink layer 310, an MRL (which may be formed, e.g., of FePt) 316 on the seed layer 314, a capping layer 318 (which may be formed, e.g., of CoFe) on the MRL 316, an amorphous metallic alloy overcoat 320 (which may be formed, e.g., of a metallic glass such as TaAuCrRu, AuRuSiOₓC, TaCrRuC, NbPdHf, NbPdHfW, NbPdHfSi, PdHfSi and NbPdHfWCrB) on the capping layer 318, and a lubricant 322 on the overcoat 320. In other examples, other amorphous metallic alloy compositions may be suitable, such as families of Ir- and Ir—Ni-containing metallic glasses. Note that the layers in FIG. 3 (and in other figures herein) are not shown to scale.

The terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

In some aspects, the layers have the following thicknesses: the substrate 302 thickness is in the range of 0.5 mm to 0.635 mm; the adhesion layer 304 thickness is in the range of 45 nm to 180 nm; the SUL 306 thickness is in the range of 55 nm to 80 nm; the heatsink layer 310 thickness is in the range of 55 nm to 100 nm; the seed layer 314 thickness is in the range of 2 nm to 5 nm (and is made of MgO, or alternatively of MgO—TiO, or of other appropriate oxide layer that promotes FePt ordering and provides good thermal barrier resistance between the recording layer and the heatsink layer); the MRL structure that may be, e.g., 100-200 Λ thick; the capping layer 318 thickness is in the range of 1 nm to 3 nm; the overcoat 320 thickness may be in the range of 10 angstroms (Å) to 20 Å, or the narrower range of 10 Å to 15 Å, or the narrower range of 12 Å to 15 Å, 12 Å or less; the lubricant layer thickness (if provided) is in the range of 7 Å to 9.5 Å.

In some examples, substrate 302 has an outer diameter (i.e., OD) of about 97 mm and a thickness of about 0.5 mm. In other examples, the OD may be 95 mm or 95.1 mm. (Generally speaking, such disks are all referred to as “3.5 inch” disks.) In some aspects, the substrate 302 may be made of one or more materials such as an Al alloy, NiP-plated Al, glass, glass ceramic, and/or combinations thereof.

In some aspects, the adhesion layer 304 (which might alternatively be referred to as a pre-seed layer) is used to reduce delamination of layers or films deposited over the adhesion layer. The adhesion layer 304 may be a metallic alloy, such as NiTa (as shown), etc.

In some aspects, the SUL 308 may be configured with CoZrWMo. In other examples, the SUL 308 can be made of one or more other soft magnetic materials, such as Co, Fe, or Ni with one or more of W, Mo, Ta, Nb, Cr, B, Si, or C, or combinations thereof. Thus, in some aspects, the SUL 308 can be made of metallic materials such as CoZrWMo, CoW, NiFe, or CoNiFe, or combinations thereof. In some examples, additional non-metallic materials can be added to the metallic materials, such as CrTa or ZrO₂. In some examples, the SUL is formed of Co or CoFe alloys with Zr, B, Ta, W, and Mo additives (to make the layer soft magnetic and amorphous). The SUL 308 may be an amorphous compound with no anisotropy. The SUL 308 may be configured and positioned to support the magnetization of the magnetic recording layer structure 316 during data storage operations. More specifically, the SUL 308 may be configured and positioned to provide a first return path for a magnetic field applied during a write operation.

In some aspects, the heatsink layer 310 can be made of one or more materials such as Cr, as shown, or Ag, Al, Au, Cu, Mo, Ru, W, CuZr, MoCu, AgPd, CrRu, CrV, CrW, CrMo, CrNd, NiAl, NiTa, combinations thereof, and/or other suitable materials known in the art.

In some aspects, the seed layer 314 is used to create a growth template for the subsequently-deposited films including the heatsink layer 310 and the MRL 316 and to provide a correct crystallographic orientation, e.g., L₁₀. Functional goals for the seed layer 314 include small grain size and good crystallographic texture, both of which may be desirable for good media recording performance. In some aspects, the seed layer 314 may include an MTO layer to assist in nucleation so as to permit proper crystal growth within the MRL 316 so that the MRL 316 will have good crystallographic texture with small grains. In some aspects, the seed layer may include an MgO layer to assist in nucleation to permit proper crystal growth within the MRL 316 and to provide a thermal barrier in combination with an MTO layer.

In some aspects, the MRL 316 includes one or more magnetic recording layers for storing data magnetically, not explicitly shown in FIG. 3. For example, the MRL 316 may include magnetic recording sub-layers and exchange control sub-layers (ECLs). Collectively, the sub-layers form an MRL structure 316 that may be, e.g., 100-200 Å thick. In some aspects, the MRL 316 may be made of FePt. In some aspects, the MRL 316 may be made instead of an alloy selected from FePtY, where Y is a material selected from Cu, Ni, and combinations thereof. In other aspects, the MRL 316 may be made instead of a CoPt alloy. In some aspects, the MRL 316 may be formed of high anisotropy L₁₀ FePt with segregants such as C, BN, SiO₂, Ag, and combinations thereof. In some aspects, the MRL is a four layer MRL. Each layer of the MRL may have segregants with the amount of segregant varying from layer to layer within the MRL. If a lubricant layer is also provided on the overcoat 320, the lubricant layer (not shown in the figure) may be made of a polymer-based lubricant material and/or other suitable materials known in the art.

In some aspects, the capping layer or layers 318 can be Co, CoPt, CoFe, or CoPd. In some embodiments, the layer or layer(s) may be made of specific combinations of materials, for example, Co/Au, Co/Ag, Co/Al, Co/Cu, Co/Ir, Co/Mo, Co/Ni, Co/Os, Co/Ru, Co/Ti, Co/V, Fe/Ag, Fe/Au, Fe/Cu, Fe/Mo, Fe/Pd, Ni/Au, Ni/Cu, Ni/Mo, Ni/Pd, Ni/Re, etc. In additional examples, the capping layer(s) may include any combination of Pt and Pd (e.g., alloys), or any of the following elements, alone or in combination: Au, Ag, Al, Cu, Ir, Mo, Ni, Os, Ru, Ti, V, Fe, Re, and the like.

In some aspects, during media fabrication, the MRL 316 is deposited such that recording grains are formed of one or more magnetic materials (e.g., FePt) and grain boundaries are formed of one or more segregants (e.g., C, BN, SiO₂, Ag, or TiO₂). The capping layer 318 is then deposited on the MRL 316 such that capping grains are formed of one or more magnetic materials (e.g., CoFe or CoPt) on the MRL grains and capping boundaries are formed of one or more capping segregants on the MRL segregants. The MRL grains and the capping grains can present a fairly rough upper surface. To decrease the roughness caused by the grain formation, the capping layer 318 may be etched until at least some of its capping grains have been planarized. In some aspects, a sacrificial layer, not shown, may be used as well, which is deposited over the capping layer. The sacrificial layer may include, e.g., at least one of: C, SiO2, Al2O3, ZrO2, or TiO2 and may be etched away along with portions of the capping layer.

As noted, the overcoat 320 may be formed of an amorphous metal such as TaAuCrRu, AuRuSiOₓC, TaCrRuC, NbPdHf, NbPdHfW, NbPdHfSi, PdHfSi and NbPdHfWCrB. The amorphous metallic alloy may be an amorphous MPEA such as 20Pd-20Nb-20Hf-20W-(remainder Cr and B). In other examples, the amorphous metallic alloy of the overcoat has principal elements that vary from 5 to 35 at. %. In one particular example, the amorphous metallic alloy is 30Pd-11Nb-35Hf-10W-10Cr-4B. Otherwise routine experimentation (e.g., phase mapping) may be performed to identify preferred or optimal values for the atomic percentages of the various elements within the alloys. In other examples, other amorphous metallic alloy compositions may be suitable, such as families of Ir- and Ir—Ni-containing metallic glasses.

The lubricant 322 may be any suitable polymer-based lubricant such as perfluoropolyether (PFPE).

Notably, FIG. 3 illustrates an illustrative example of a HAMR stack with a particular combination and arrangement of layers. In other examples, more or fewer layers may be provided. For example, in some examples, the MTO or the adhesion layer might be omitted. In other examples, additional layers or films might be provided, such as a thermal resistive layer (which may be formed, e.g., of RuAlTiO₂) above the heatsink and below the MRL. Generally speaking, there may be various tradeoffs in different aspects of performance (e.g., thermal performance vs. magnetic performance) to the various arrangements.

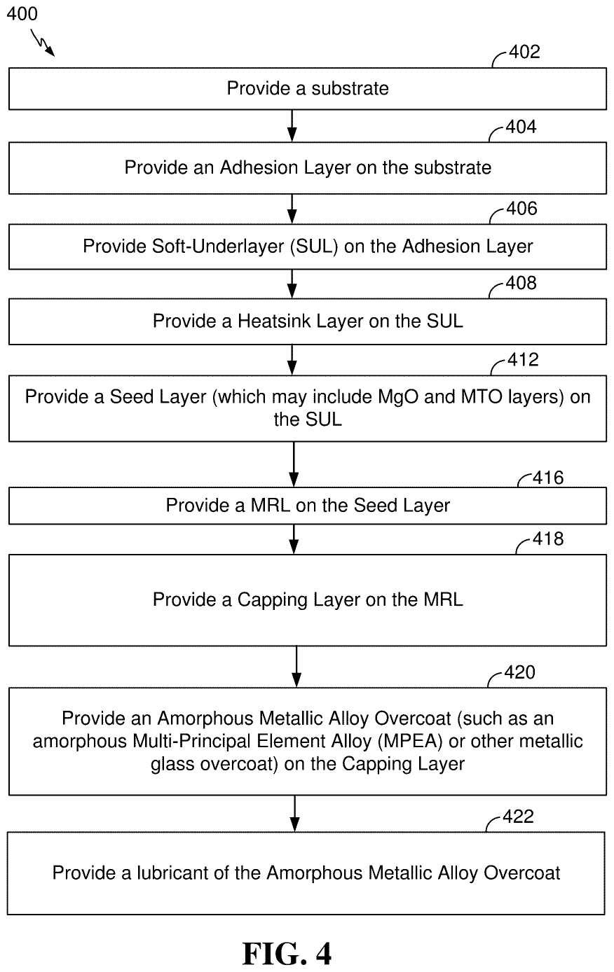

FIG. 4 is a flowchart of a process 400 for fabricating a HAMR medium that includes an amorphous metallic alloy overcoat in accordance with some aspects of the disclosure. In one aspect, process 400 can be used to fabricate the HAMR media described above in relation to FIG. 3. In block 402, the process provides a substrate. In block 404, the process provides an adhesion layer (which may be formed, e.g., of NiTa) on the substrate. In block 406, the process provides an SUL on the adhesion layer (which may be formed, e.g., of CoZrWMo). In block 408, the process provides a heatsink layer (which may be formed, e.g., of Cr) on the SUL. In block 412, the process provides a seed layer (which may include MgO and MTO layers as discussed above) on the heatsink layer. In block 416, the process provides an MRL on the seed layer. The MRL may be formed, e.g., of FePt having an L₁₀-ordered structure, e.g., a high anisotropy L₁₀ FePt with segregants such as C, BN, SiO₂, Ag, and combinations thereof. In block 418, the process provides a capping layer on the MRL. In block 418, the process provides a capping layer on the MRL. See, exemplary capping compounds above.

In block 420, the process provides an amorphous metallic alloy overcoat, such as a metallic glass (e.g., TaAuCrRu, AuRuSiOₓC, TaCrRuC, NbPdHf, NbPdHfW, NbPdHfSi, PdHfSi and NbPdHfWCrB) on the capping layer. The amorphous metallic alloy may be an amorphous MPEA such as 20Pd-20Nb-20Hf-20W-(remainder Cr and B). In other examples, the amorphous metallic alloy of the overcoat has principal elements that vary from 5 to 35 at. %. In one particular example, the amorphous metallic alloy is 30Pd-11Nb-35Hf-10W-10Cr-4B. In other examples, other amorphous metallic alloy compositions may be suitable, such as families of Ir- and Ir—Ni-containing metallic glasses. In block 422, the process also provides a lubricant layer on the overcoat. Additional or alternative exemplary materials are listed above.

Insofar as the processes described herein are concerned, the processes can in some cases perform the sequence of actions in a different order. In another aspect, the process can skip one or more of the actions. In other aspects, one or more of the actions are performed simultaneously. In some aspects, additional actions can be performed. The deposition of at least some of the layers can be performed using any of a variety of deposition processes or sub-processes, including, but not limited to physical vapor deposition (PVD), DC sputter deposition and ion beam deposition, plasma enhanced chemical vapor deposition (PECVD) and other forms of chemical vapor deposition (CVD) besides PECVD, low pressure chemical vapor deposition (LPCVD) and atomic layer chemical vapor deposition (ALCVD). In other aspects, other suitable deposition techniques known in the art might also be used. As noted above, DC sputtering may be advantageously be employed to form the amorphous metallic alloy overcoat.

### PMR Media Example

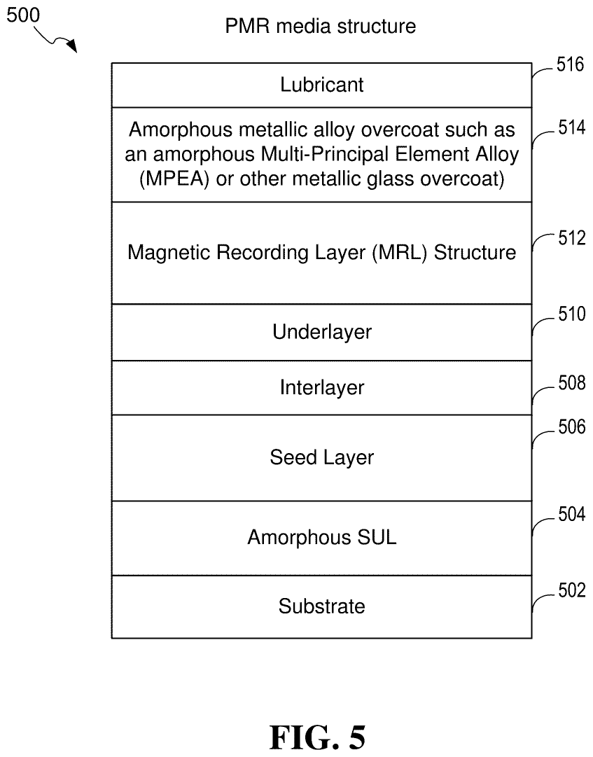

FIG. 5 is a side cross-sectional schematic view of a magnetic recording medium 500 configured for use with PMR that includes an amorphous metallic alloy overcoat in accordance with an aspect of the disclosure. The magnetic recording medium 500 has a stacked structure. In sequence from the bottom, the medium 500 includes a substrate 502, an amorphous SUL 504, a seed layer 506, an interlayer 508, an underlayer 510, an MRL structure 512, an overcoat layer 514 formed of an amorphous metallic alloy (such as metallic glass overcoat), and a lubricant 516. In some examples, the MRL structure 512 has multiple magnetic recording layers and multiple non-magnetic ECLs. Additional layers or films may be provided.

The substrate 502 can be made of one or more materials such as an aluminum (Al) alloy, nickel-phosphorus (NiP)-plated Al, glass, glass ceramic, and/or combinations thereof. In one embodiment, the substrate 502 may be a rigid substrate (e.g., glass or ceramic).

The amorphous SUL 504 can be made of one or more ferromagnetic materials with high permeability, high saturation magnetization and low coercivity, such as cobalt (Co), iron (Fe), molybdenum (Mo), tantalum (Ta), niobium (Nb), boron (B), chromium (Cr), or other soft magnetic materials, or combinations thereof. The amorphous SUL 504 may include an amorphous compound or combination of Co and Fe (e.g., a CoFe alloy) with the addition of one or more non-magnetic elements from Mo, Nb, Ta, W, and B. The SUL 504 may be configured to support magnetization of the magnetic recording layer structure 512 during data storage operations. More specifically, the amorphous SUL 504 may be configured to provide a return path for a magnetic field applied during a write operation.

The amorphous SUL 504 has a thickness in the range of 80 to 180 Angstroms. In one embodiment, the thickness of the amorphous SUL 504 is 150 Angstroms.

The seed layer 506 may be formed, e.g., of Co or Ni a thickness in the range of 20 to 40 Å. The seed layer provides a smooth surface with a specific crystal structure to facilitate growth of the MRL and promote perpendicular magnetization.

The interlayer 508, which is optional in some embodiments, may be formed of Co and Cr, and an additional metal, such as Ru. For example, the interlayer, formed on the seed layer, may be provided to promote lattice matching between the seed layer and the underlayer, which in turn helps to maintain proper crystallographic texture of the magnetic recording layers. (Crystallographic texture generally refers to the distribution of crystallographic orientations of a polycrystalline structure.)

The underlayer 510, which is optional in some embodiments, may be made of one or more materials such as Ru and/or other suitable materials known in the art. The underlayer may be, for example, sputter deposited onto the interlayer to achieve a desired grain size and topography to facilitate growth of small magnetically-decoupled grains within the MRL that are grown on the underlayer.

The MRL 512 may be made of CoFe. In some examples, the crystallographic orientation of the MRL 512 can facilitate PMR.

The overcoat 514 may be an amorphous metallic alloy overcoat (which may be formed, e.g., of a metallic glass such as TaAuCrRu, AuRuSiOₓC, TaCrRuC, NbPdHf, NbPdHfW, NbPdHfSi, PdHfSi and NbPdHfWCrB. In one example, the metallic glass may be 30Pd-11Nb-35Hf-10W-10Cr-4B. In some aspects, the amorphous metallic alloy may be regarded as an MPEA. In other examples, other amorphous metallic alloy compositions may be suitable, such as families of Ir- and Ir—Ni-containing metallic glasses. The overcoat 514 thickness may be in the range of 10 Å to 20 Å, or the narrower range of 10 Å to 15 Å, or the narrower range of 12 Å to 15 Å, or less than 12 Å.

The lubricant may be a polymer-based lubricant such as PFPE and/or other suitable materials known in the art and have a thickness in the range of 7 Å to 9.5 Å.

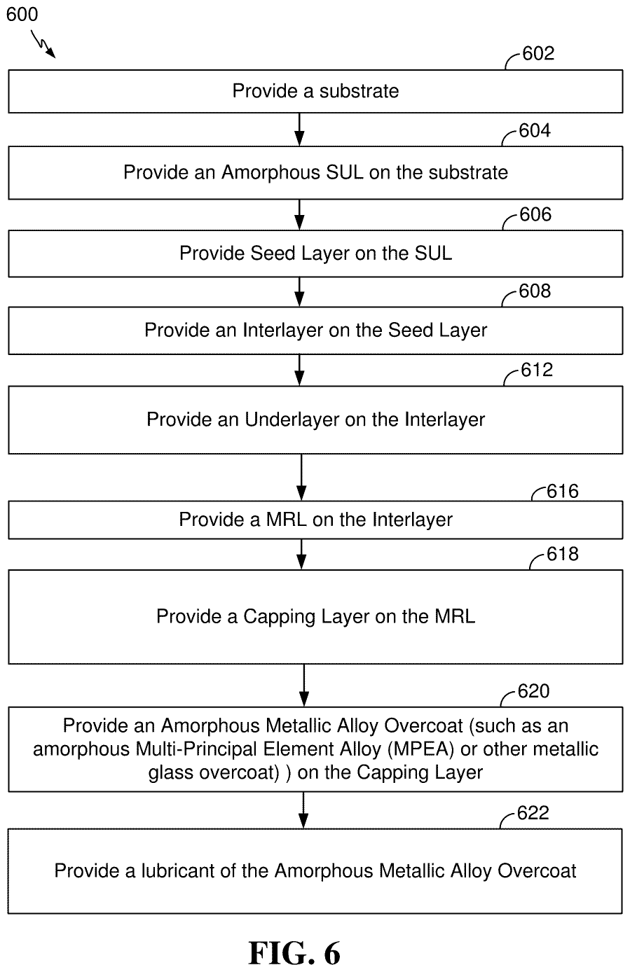

FIG. 6 is a flowchart of a process 600 for fabricating a PMR medium. In particular embodiments, the process 600 can be used to fabricate the magnetic recording media described above as medium 500. At block 602, the process provides a substrate. At block 604, a soft magnetic underlayer (e.g., SUL 504 in FIG. 5) is provided on the substrate. At block 606, a seed layer is provided on the SUL. At block 608, an interlayer is provided on the seed layer. At block 610, an underlayer may optionally be provided on the interlayer. The underlayer may be made of one or more materials such as Ru and/or other suitable materials known in the art. At block 612, a magnetic recording layer structure (e.g., MRL structure 512 in FIG. 5) is provided on the underlayer. In some embodiments, the magnetic recording layer structure has or includes multiple non-magnetic ECLs. In block 618, the process provides a capping layer on the MRL. In block 620, the process provides an amorphous metallic alloy overcoat, such as a metallic glass (e.g., TaAuCrRu, AuRuSiOₓC, TaCrRuC, NbPdHf, NbPdHfW, NbPdHfSi, PdHfSi and NbPdHfWCrB) on the capping layer. In block 622, the process also provides a lubricant layer on the overcoat. Additional or alternative exemplary materials are listed above.

Insofar as the processes described herein are concerned, the processes can in some cases perform the sequence of actions in a different order. In another aspect, the process can skip one or more of the actions. In other aspects, one or more of the actions are performed simultaneously. In some aspects, additional actions can be performed. The deposition of at least some of the layers can be performed using any of a variety of deposition processes or sub-processes, including, but not limited to PVD, DC sputter deposition and ion beam deposition, PECVD and other forms of CVD besides PECVD, LPCVD and ALCVD. In other aspects, other suitable deposition techniques known in the art might also be used. As noted above, DC sputtering may be advantageously be employed to form the amorphous metallic alloy overcoat.

### Additional Examples and Embodiments

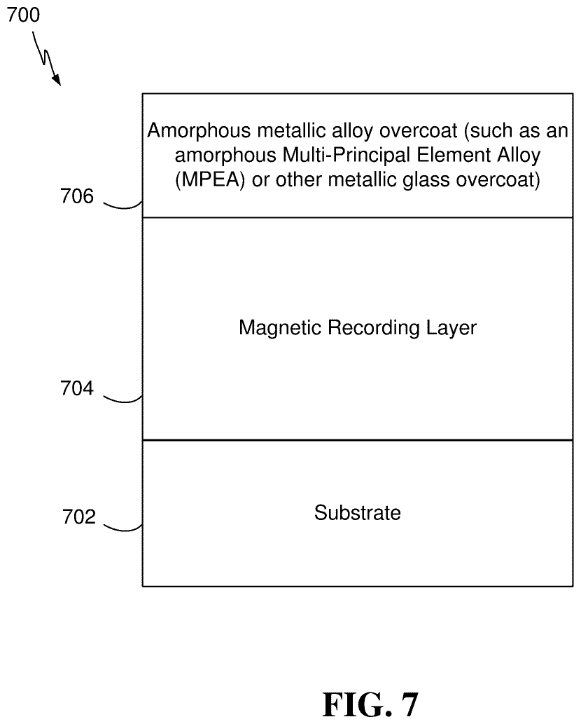

FIG. 7 is a side schematic view of an exemplary magnetic recording medium 700 in accordance with another aspect of the disclosure. The magnetic recording medium 700 has a stacked structure with a substrate 702, an MRL 704 on the substrate 702, and an overcoat layer 706 formed of an amorphous metallic alloy such as an amorphous MPEA or other metallic glass overcoat (e.g., a metallic glass overcoat such as TaAuCrRu, AuRuSiOₓC, TaCrRuC, NbPdHf, NbPdHfW, NbPdHfSi, PdHfSi and NbPdHfWCrB) on the MRL 704. In one example, the metallic glass may be 30Pd-11Nb-35Hf-10W-10Cr-4B. See, other examples listed above. In other examples, other amorphous metallic alloy compositions may be suitable, such as families of Ir- and Ir—Ni-containing metallic glasses.

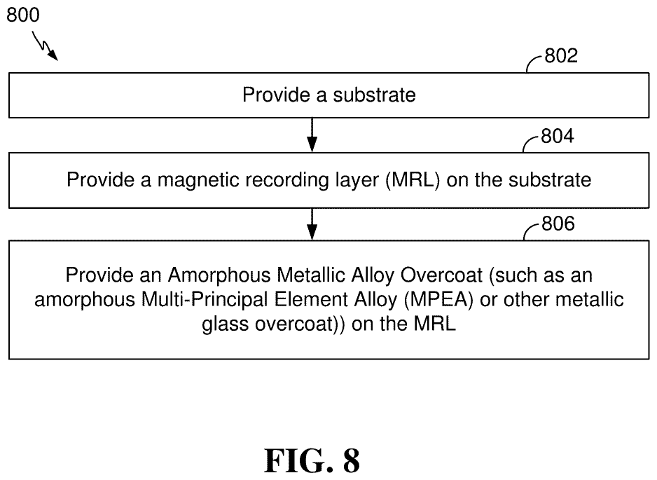

FIG. 8 is a flowchart of a process 800 for fabricating a magnetic recording medium. In particular embodiments, the process 800 can be used to fabricate the magnetic recording media described above. At block 802, the process provides a substrate. At block 804, a magnetic recording layer structure is provided on the underlayer. In some embodiments, the magnetic recording layer structure has or includes multiple non-magnetic ECLs. In block 806, the process provides an amorphous metallic alloy overcoat such as an amorphous MPEA or other metallic glass overcoat (e.g., TaAuCrRu, AuRuSiOₓC, TaCrRuC, NbPdHf, NbPdHfW, NbPdHfSi, PdHfSi and NbPdHfWCrB) on the MRL. In one example, the metallic glass may be 30Pd-11Nb-35Hf-10W-10Cr-4B. In some aspects, the amorphous metallic alloy may be regarded as an MPEA. See, other examples listed above. In other examples, other amorphous metallic alloy compositions may be suitable, such as families of Ir- and Ir—Ni-containing metallic glasses.

### Exemplary Test Results Pertaining to Lubricant Uptake and Corrosion Resistance

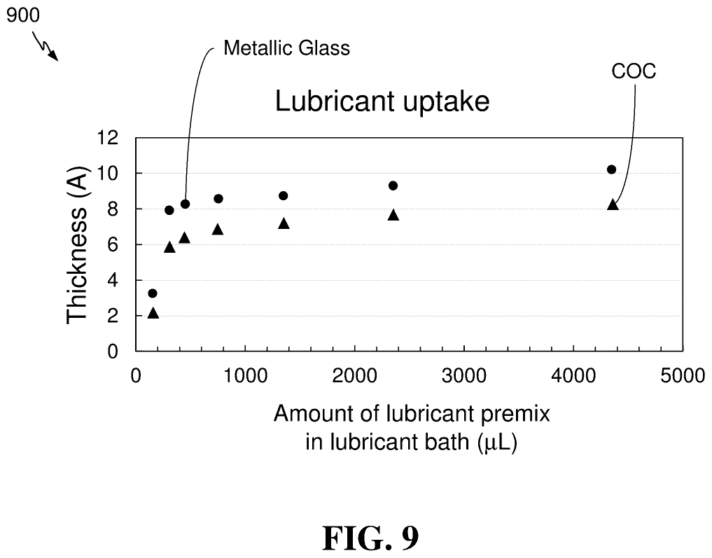

FIG. 9 is a graph 900 showing lubricant uptake, i.e., the amount of lubricant that is retained on the overcoat when the magnetic recording disk is dipped into a lubricant bath. Within FIG. 9, the x-axis represents the amount of lubricant (in micro-liters, μL)) provided within a lubricant bath that the magnetic recording disk is dipped into. The y-axis represents the resulting thickness in Å of the lubricant retained on the overcoat of the disk after removal from the bath. The black circles represent amorphous metallic alloy overcoat values. The black triangles represent the conventional COC. As noted above, when using a lubricant on an amorphous metallic alloy overcoat, lubricant uptake is at least as effective as with a conventional COC without needing N₂. Indeed, for the particular amorphous metallic alloy overcoat of FIG. 9, which is 30Pd-11Nb-35Hf-10W-10Cr-4B, lubricant uptake is improved as compared to a conventional COC (which has N₂ implantation).

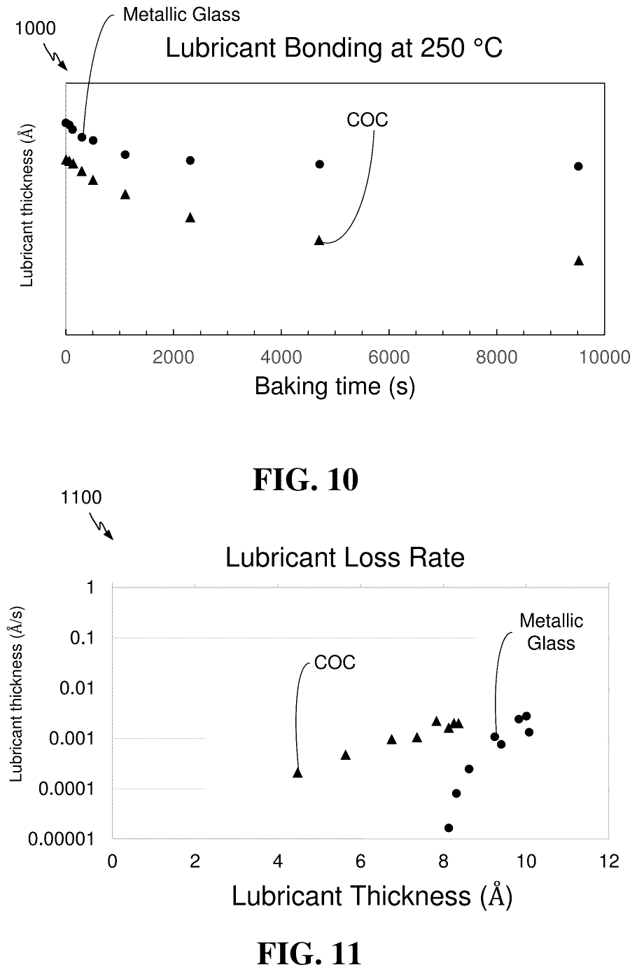

FIG. 10 is a graph 1000 showing lubricant bonding, i.e., the amount of lubricant that remains on the overcoat despite extended baking times. Within FIG. 10, the x-axis represents the baking time (in seconds) at 250° C. The y-axis represents the thickness in Å of the lubricant that remains on the overcoat of the disk after baking. As shown in FIG. 10, for the particular amorphous metallic alloy overcoat of FIG. 10, which is 30Pd-11Nb-35Hf-10W-10Cr-4B, lubricant bonding is improved as compared to a conventional COC (which has N₂ implantation) for all baking times, with much greater retention for longer durations.

FIG. 11 is a graph 1100 showing lubricant loss rate, which is derived from the data in FIG. 10. Within FIG. 11, the x-axis represents lubricant thickness in Å. The y-axis represents the loss rate expressed in Å/second. As shown in FIG. 11, for the particular amorphous metallic alloy overcoat of FIG. 10, which is again 30Pd-11Nb-35Hf-10W-10Cr-4B, lubricant loss rate is much lower as compared to a conventional COC (which has N₂ implantation). Indeed, the lubricant appears to be bonding to the metallic glass.

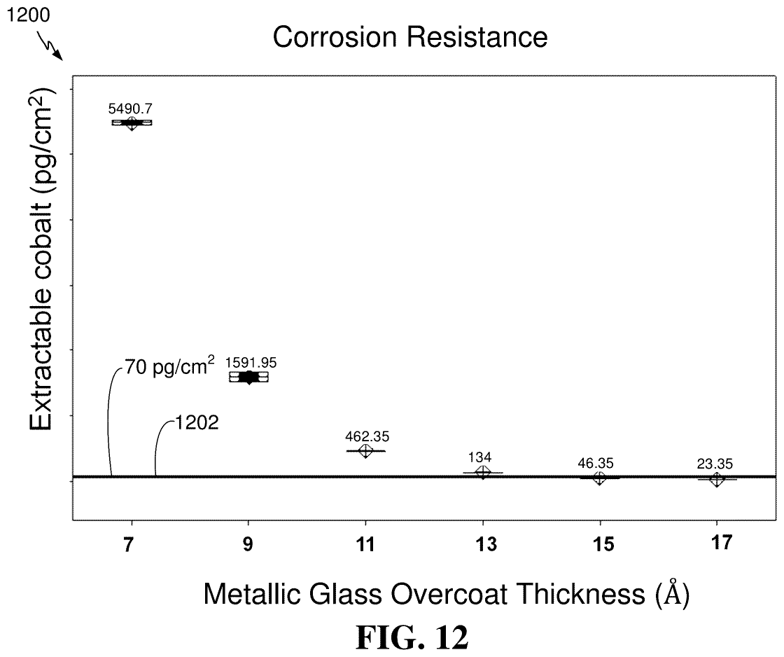

FIG. 12 is a graph 1200 showing corrosion resistance based on a cobalt extraction test. Briefly, hydrochloric acid is dripped onto a magnetic recording disk with a metallic glass overcoat on a capping layer containing cobalt (e.g., a CoFe capping layer). The amount of Co within the hydrochloric acid is measured to assess the amount of corrosion caused by the hydrochloric acid. Within FIG. 12, the x-axis represents thickness in Å of the metallic glass, which is 30Pd-11Nb-35Hf-10W-10Cr-4B. The y-axis represents the amount of Co extracted in picograms (pg) per cm², with the particular pg/cm² values for various thickness shown adjacent to the data point. The horizontal line 1202 shows a preferred specification limit or threshold for a 95 mm disk of 70 μg/cm². As shown, when using the metallic glass, this specification is achieved with an overcoat thickness of only about 15 Å. In contrast, although not shown in FIG. 12, a typical COC requires a thickness of at least 21 Å-25.5 Å to achieve at least 70 pg/cm² of corrosion resistance. In other words, when using metallic glass, a much thinner overcoat can be used while still providing satisfactory corrosion resistance. As noted above, a thinner overcoat enables the read head to be placed closer to the MRL of the disk, thus providing a stronger read back signal, ultimately allowing increased disk capacity

### ADDITIONAL ASPECTS

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to be limiting of the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on. The term “about ‘value X’”, or “approximately value X,” as used in the disclosure shall mean within 10 percent of the ‘value X’. For example, a value of about 1 or approximately 1, would mean a value in a range of 0.9-1.1. In one aspect, “about” as used herein may instead mean 5 percent. In this disclosure, various numerical values are presented. Unless specifically indicated otherwise, it is contemplated that these numerical values may have a tolerance of 10 percent. In another aspect, the tolerance may be 5 percent. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. Various components described in this specification may be described as “including” or made of certain materials or compositions of materials. In one aspect, this can mean that the component consists of the particular material(s). In another aspect, this can mean that the component comprises the particular material(s).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

1. A magnetic recording medium, comprising:
a substrate;
a magnetic recording layer on the substrate;
an overcoat comprising an amorphous metallic alloy on the magnetic recording layer with the magnetic recording layer between the substrate and the overcoat; and
a lubricant layer on the overcoat.

2. The magnetic recording medium of claim 1, wherein the amorphous metallic alloy comprises a metallic glass.

3. The magnetic recording medium of claim 2, wherein the metallic glass comprises at least one of TaAuCrRu, AuRuSiOₓC (with x between 0 and 2, inclusive), TaCrRuC, NbPdHf, NbPdHfW, NbPdHfSi, PdHfSi and NbPdHfWCrB.

4. The magnetic recording medium of claim 2, wherein the metallic glass comprises 30Pd-11Nb-35Hf-10W-10Cr-4B.

5. The magnetic recording medium of claim 2, wherein the metallic glass comprises an amorphous alloy formed of four principal elements, each of which comprises between 5% and 35%, inclusive, of the alloy, and with all elements of the alloy totaling 100 at. %.

6. The magnetic recording medium of claim 1, wherein the amorphous metallic alloy comprises an amorphous multi-principal element alloy (MPEA).

7. The magnetic recording medium of claim 1, wherein the metallic alloy comprises 20Pd-20Nb-20Hf-20 W and a remainder of Cr and B.

8. The magnetic recording medium of claim 1, wherein the amorphous metallic alloy includes Ir.

9. The magnetic recording medium of claim 1, wherein the magnetic recording medium is configured for heat-assisted magnetic recording and further comprises:
a heatsink layer on the substrate; and
a seed layer on the heatsink layer;
with the magnetic recording layer on the seed layer.

10. The magnetic recording medium of claim 1, wherein the magnetic recording medium is configured for perpendicular magnetic recording and further comprises:
a soft underlayer (SUL) on the substrate;
a seed layer on the SUL; and
an underlayer on the SUL;
with the magnetic recording layer on the underlayer.

11. The magnetic recording medium of claim 1, wherein the overcoat has a density in the range of 13 grams/cm³ to 15 grams/cm³.

12. The magnetic recording medium of claim 1, wherein the overcoat has a thickness of 12 angstroms (Å) or less.

13. The magnetic recording medium of claim 1, wherein the overcoat has a thickness in the range of 10-20 angstroms (Å).

14. A data storage device comprising:
a slider comprising a magnetic recording head; and
the magnetic recording medium of claim 1,
wherein the slider is configured to write information to the magnetic recording layer of the magnetic recording medium during a write operation.

15. A method for fabricating a magnetic recording medium, the method comprising:
providing a substrate;
providing a magnetic recording layer on the substrate; and
providing an overcoat comprising an amorphous metallic alloy on the magnetic recording layer with the magnetic recording layer between the substrate and the overcoat;
providing a lubricant layer on the overcoat.

16. The method of claim 15, wherein the amorphous metallic alloy comprises a metallic glass.

17. The method of claim 16, wherein the metallic glass comprises at least one of TaAuCrRu, AuRuSiOₓC (with x between 0 and 2, inclusive), TaCrRuC, NbPdHf, NbPdHfW, NbPdHfSi, PdHfSi and NbPdHfWCrB.

18. The method of claim 15, wherein the amorphous metallic alloy includes Ir.

19. The magnetic recording medium of claim 15, wherein the amorphous metallic alloy comprises an amorphous multi-principal element alloy (MPEA).

20. A magnetic recording medium configured for heat-assisted magnetic recording, the magnetic recording medium comprising:
a substrate;
a heatsink layer on the substrate;
a seed layer on the heatsink layer;
a magnetic recording layer on the seed layer;
a capping layer directly on the magnetic recording layer; and
an overcoat directly on the capping layer, the overcoat comprising a metallic glass, and wherein the capping layer comprises a different material from the magnetic recording layer and from the overcoat.

21. The magnetic recording medium of claim 20, wherein the metallic glass comprises an amorphous alloy formed of four principal elements, each of which comprises between 5% and 35%, inclusive, of the alloy, and with all elements of the alloy totaling 100 at. %.

22. The magnetic recording medium of claim 1, further comprising a capping layer, wherein the overcoat is directly on the capping layer, and the capping layer is directly on the magnetic recording layer, and wherein the capping layer comprises a different material from the magnetic recording layer and from the overcoat.

23. The magnetic recording medium of claim 1, wherein the overcoat comprises a different material from the magnetic recording layer.

24. The method of claim 15, further comprising providing a capping layer, wherein the overcoat is provided directly on the capping layer, and the capping layer is provided directly on the magnetic recording layer, and wherein the capping layer is formed of a different material from the magnetic recording layer and from the overcoat.

25. The method of claim 15, wherein the overcoat comprises a different material from the magnetic recording layer.

26. The method of claim 15, wherein the lubricant layer is directly on the overcoat.

27. The method of claim 15:
wherein the substrate comprises a material configured to provide structural rigidity for the magnetic recording medium; and
wherein the magnetic recording layer comprising a plurality of magnetic recording grains configured to store information.

28. The magnetic recording medium of claim 1, wherein the lubricant layer is directly on the overcoat.

29. The magnetic recording medium of claim 1:
wherein the substrate comprises a material configured to provide structural rigidity for the magnetic recording medium; and
wherein the magnetic recording layer comprising a plurality of magnetic recording grains configured to store information.
